(19) United States
(12) Patent Application Publication
(10) Pub. No.: US 2008/0047818 A1
(43) Pub. Date: Feb. 28, 2008

(54) ACTUATOR SYSTEM FOR A POWER MODIFIER SUCH AS A LIGHT SWITCH

(76) Inventor: Matthew J. Holcomb, Metamora, MI (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/829,803

(22) Filed: Jul. 27, 2007

Related U.S. Application Data
(60) Provisional application No. 60/834,639, filed on Jul. 31, 2006.

(51) Int. Cl. H01H 43/04

(52) U.S. Cl. 200/52 R

(57) ABSTRACT

The invention relates to an actuator system for a power modifier of the kind having a power modifier body that is secured to a wall, first and second terminals over which a voltage is applied, a power-modifying portion that modifies electric power from the first terminal to the second terminal, and a power modifier member, movably secured to the power modifier body and connected to the power-modifying portion so that the power-modifying portion modifies the electric power upon movement of the power modifier member relative to the power modifier body and the wall. The actuator system includes an actuator body that is securable in a stationary position relative to the wall, a reference source, and an actuator connected to the reference source, the actuator having a stationary portion secured in a stationary position to the actuator body and a movable portion that moves relative to the actuator body, the movable portion having a surface that engages with the power modifier member of the power modifier to move the power modifier member in response to the reference source.

### CROSS-REFERENCE TO RELATED APPLICATIONS

This application claims priority from U.S. Provisional Patent Application No. 60/834,639, filed on Jul. 31, 2006, which is incorporated herein by reference in its entirety.

### BACKGROUND OF THE INVENTION

1). Field of the Invention

This invention relates to an actuator system for a power modifier such as a light switch.

2). Discussion of Related Art

A timer is often used between a wall outlet and a light for purposes of switching the light on and off, for example when the owner of a house is away. In such a timer, the wall outlet supplies power to both the timer and the light switch, which is attached to the timer. Such a device is useful to control individual lights, but is not able to control lights that are hard-wired into a house.

If the light in a room is controlled with a wall-mounted switch, a programmable outlet can be used to switch the light on and off. A programmable outlet, however, must be installed directly into an opening in a wall, and is thus more expensive and a more permanent addition to the room.

### SUMMARY OF THE INVENTION

The invention relates to an actuator system for a power modifier of the kind having a power modifier body that is secured to a wall, first and second terminals over which a voltage is applied, a power-modifying portion that modifies electric power from the first terminal to the second terminal, and a power modifier member, movably secured to the power modifier body and connected to the power-modifying portion so that the power-modifying portion modifies the electric power upon movement of the power modifier member relative to the power modifier body and the wall. The actuator system includes an actuator body that is securable in a stationary position relative to the wall, a reference source, and an actuator connected to the reference source, the actuator having a stationary portion secured in a stationary position to the actuator body and a movable portion that moves relative to the actuator body, the movable portion having a surface that engages with the power modifier member of the power modifier to move the power modifier member in response to the reference source.

The power modifier member may be a lever arm that is pivoted by the movable portion of the actuator.

The power modifier body may be securable within an opening in a wall, and a face plate may be securable over the opening in the wall, further comprising a securing device, having a first component securable to the face plate and a second component securable to the actuator body, thereby securing the actuator body to the face plate.

The first and second components of the securing device may include first and second magnets with their polarities in substantially the same direction so that they attract one another.

The reference source may include a clock.

The actuator system may further comprise an input device, a processor, and memory, the memory having a program stored thereon that is executable by the processor to allow for setting of an actuation time, the processor comparing the actuation time with a time provided by the clock for purposes of moving the movable portion of the actuator.

The actuator system may further comprise battery terminals, the reference source being connected to the battery terminals.

The actuator system may further comprise battery terminals, the actuator motor being connected to the battery terminals.

The actuator system may further comprise an amplifier between the reference source and the actuator motor.

The movable portion of the actuator may move the power modifier member in first and second opposing directions so that the movable portion moves the power modifier member to respectively increase and decrease the electric power from the first terminal to the second terminal.

The reference source may include a clock, further comprising an input device, a processor, and memory, wherein a program is stored in the memory, the program being executable by the processor to allow for entering of first and second actuation times, the processor comparing the first and second actuation times with a time provided by the clock to move the movable portion into the first and second directions, respectively.

### BRIEF DESCRIPTION OF THE DRAWINGS

The invention is further described by way of examples with reference to the accompanying drawings, wherein:

FIG. 1 is a cross-sectional side view that illustratively shows a wall, a switch, a face plate, and an actuator system for the switch, according to an embodiment of the invention;

FIG. 2 is a perspective view showing external surfaces of the switch, face plate, and actuator system before the actuator system is secured to the face plate;

FIG. 3 is a perspective view showing internal components of the actuator system;

FIG. 4 is a block diagram showing electric components of the actuator system; and

FIG. 5 is a flow chart illustrating the functioning of a program forming part of the actuator system.

### DETAILED DESCRIPTION OF THE INVENTION

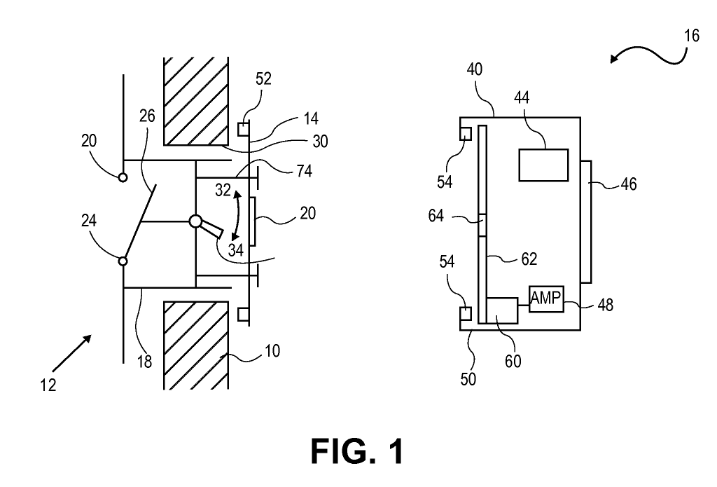

FIG. 1 of the accompanying drawings illustrates a vertical wall 10, a switch 12, a face plate 14, and an actuator system 16, according to an embodiment of the invention. The switch 12 includes a switch body 18, first and second terminals 20 and 24, a relay 26, and a switch member 28. The wall 10 has an opening 30 formed therein.

The switch member 28 is a lever arm that is mounted to the switch body 18 for pivotal movement in upward and downward directions 32 and 34. The terminals 20 and 24 are also mounted to the switch body 18. The relay 26 has a portion that is permanently and pivotably secured to the second terminal 24, and a second portion that can be moved between a first position distant from the first terminal 20 and a second position in contact with the first terminal 20.

A voltage can be applied over the first and second terminals 20 and 24. When the relay 26 is not connected to the first terminal 20, no current, and therefore no power, flows from the first terminal 20 to the second terminal 24. When the relay 26 is connected to the first terminal 20, current and power are provided from the first terminal 20 through the relay 26 to the second terminal 24. The switch member 28 is connected to the relay 26 such that pivotal movement of the switch member 28 into the up direction 32 brings the relay 26 into contact with the first terminal 20, and movement in the downward direction 34 moves the relay 26 out of contact with the first terminal 20. The switch member 28 is thus used to switch electric power on and off.

The switch body 18 is located within the opening 30 in the wall 10. Fasteners (not shown) are used to secure the switch body 18 in a stationary position to the stationary wall 10.

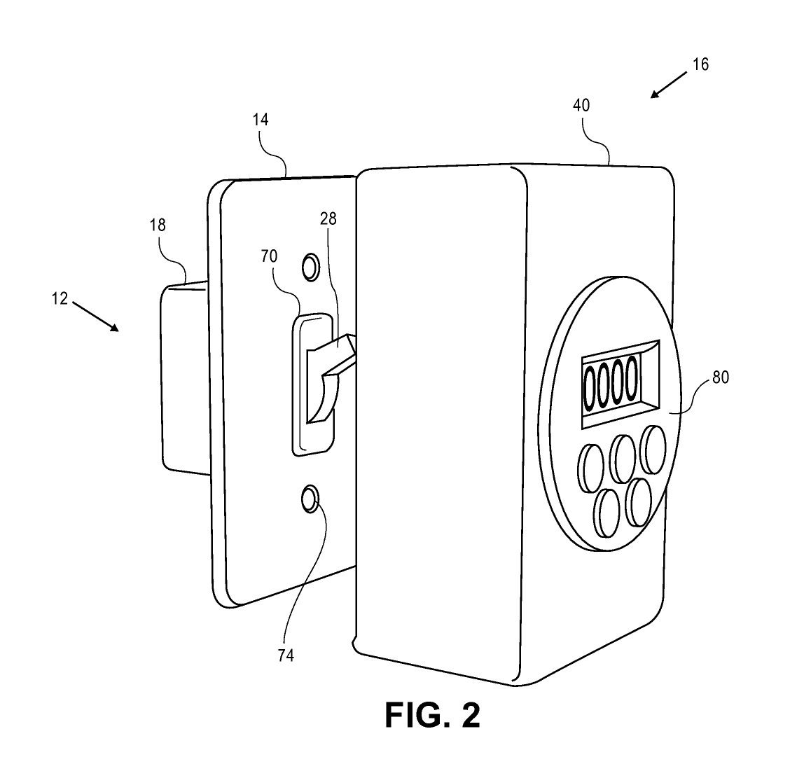

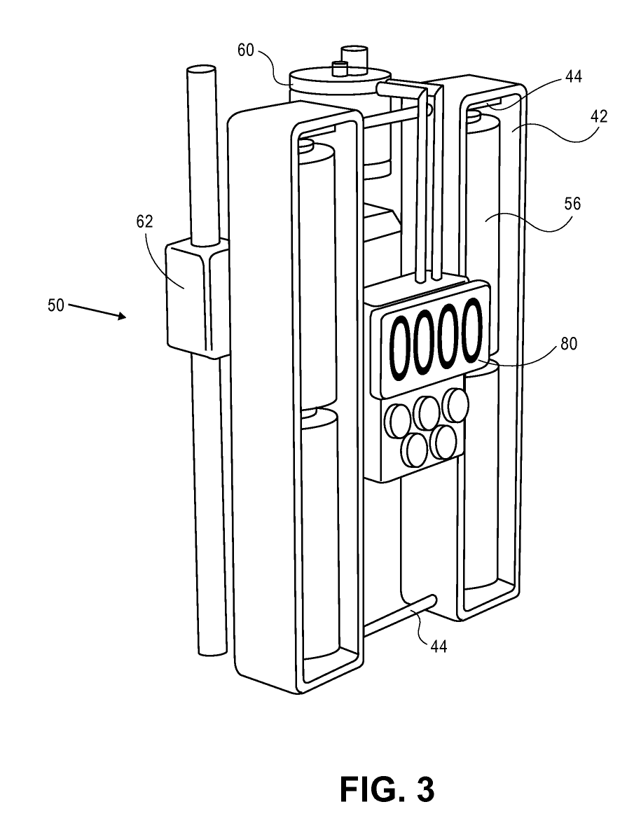

Referring to FIGS. 1, 2, and 3, the actuator system 16 includes an actuator body 40 defining two compartments 42 for batteries, positive and negative battery terminals 44 partially located within the compartments 42, a reference source 46, an amplifier 48, and an actuator 50, all directly or indirectly mounted to the actuator body 40. The actuator system 16 further includes first and second sets of magnets 52 and 54, respectively. The first set of magnets 52 is attached to a rear of the face plate 14. The second set of magnets 54 is attached to a front surface of a rear lip of the actuator body 40.

Batteries 56 are insertable into the compartments 42. Two of the batteries 56 are located in series in one of the compartments 42, and two more of the batteries 56 are located in the other compartment 42. Positive terminals of two of the batteries 56 make contact with one of the terminals 44, and negative terminals of the other two batteries make contact with the other terminal 44.

The actuator 50 includes an actuator motor 60 and an actuator mechanism 62. The actuator motor 60 has a housing that is mounted in a stationary position relative to the actuator body 40, and a shaft that is rotatably mounted to the housing. The actuator motor 60 also has a coil to which current can be provided, so as to rotate the shaft relative to the housing.

The actuator mechanism 62 is mounted for vertical up and down movement relative to the actuator body 40. The actuator mechanism 62 is also connected to the shaft of the actuator motor 60 so that rotation of the shaft of the actuator motor 60 causes vertical up and down movement of the actuator mechanism 62. The actuator mechanism 62 has a slot 64 formed therein.

In use, the face plate 14 is positioned over the opening 30 in the wall 10, and the switch member 28 protrudes through an opening 70 in the face plate 14. Screws 74 serve as fasteners that secure the face plate 14 to the switch body 18.

The actuator system 16 is then positioned against the face plate 14. Each one of the magnets 54 corresponds to a respective one of the magnets 52. The magnets 52 and 54 have polarities that are in the same direction, so that each one of the magnets 54 is attracted to a respective one of the magnets 52. The magnets 52 and 54 are thus first and second portions of securing devices that secure the actuator body 40 to the face place 14. The actuator body 40 and other components of the actuator system 16 are thus secured through the face plate 14, the screws 74, and the switch body 18 to the wall 10. The only components of the actuator system 16 that are movable relative to the wall 10 are the actuator mechanism 62 and the shaft of the actuator motor 60.

The slot 64 in the actuator mechanism 62 is positioned over the switch member 28. The slot 64 has upper and lower surfaces that are positioned above upper and lower surfaces of the switch member 28. Downward movement of the actuator mechanism 62 brings the upper surface of the slot 64 into contact with the upper surface of the switch member 28, and further movement of the actuator mechanism 62 in a downward direction moves the switch member 28 in the downward direction 34. Should movement of the actuator mechanism 62 be reversed, the lower surface of the slot 64 is brought into contact with the lower surface of the switch member 28, and further upward movement of the actuator mechanism 62 moves the switch member 28 in the upward direction 32. The actuator 50 can thus be used to switch the electric power of the switch 12 alternately off and on.

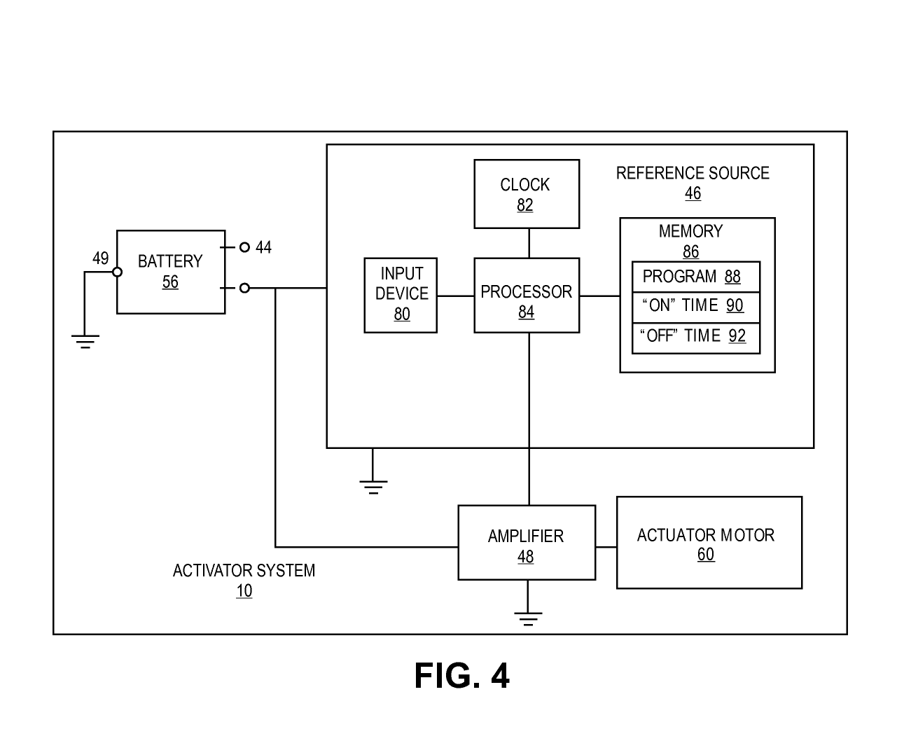

FIG. 4 illustrates electric components of the actuator system 16 in more detail. The positive terminal 44 connected to each battery 56 is connected to ground. The negative terminal 44 connected to each battery 56 is connected to both the reference source 46 and to the amplifier 48, as hereinbefore described. The reference source 46 is also connected to ground, and includes an input device 80, a clock 82, a processor 84, and memory 86. The memory 86 is connected to the processor 84, and includes a program 88 that is executable by the processor 84. The input device 80 is also connected to the processor, and in the present example includes a keypad and a liquid crystal display. The program 88, executed by the processor 84, permits a user to use the input device 80 to enter an “on” time 90 and an “off” time 92, which are stored in the memory 86. The clock 82 is also connected to the processor 84. The program 88, executed by the processor 84, compares the “on” time 90 and the “off” time 92 to a time provided by the clock 82, and provides signals to the amplifier 48 based on such comparisons.

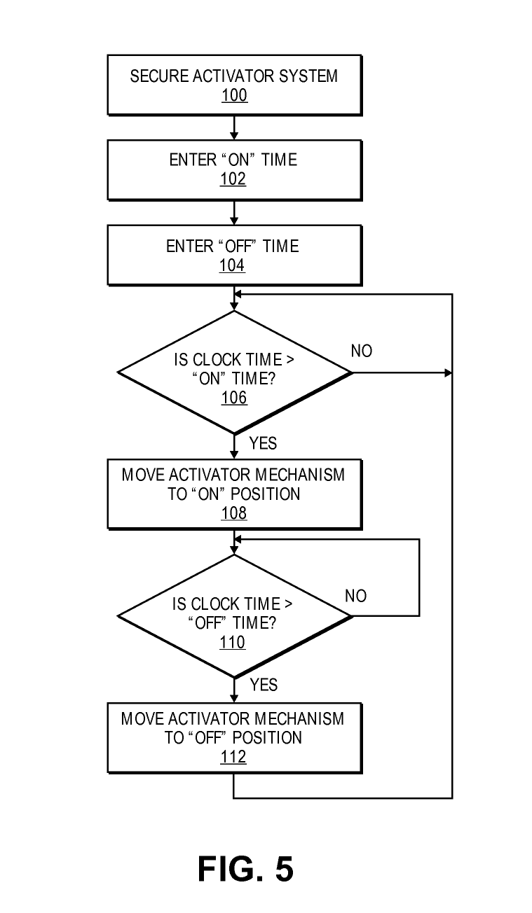

The user also uses the input device 80 to set or “arm” the actuator system 16, and can also use the input device 80 to disarm the actuator system 16. FIG. 5 illustrates how the actuator system 6 is used when it is armed.

At step 100, the user secures the actuator system 16 as described with reference to FIGS. 1, 2, and 3. At step 102, the user enters the “on” time 90, which is stored in the memory 86. At step 104, the user enters the “off” time 92, which is also stored in the memory 86. At step 106, the processor 84 continually compares the clock time provided by the clock 82 to the “on” time 90 in the memory 86. If the clock time is not larger than the “on” time, no further action is performed. If the clock time is larger than the “on” time, step 108 is executed.

At step 108, the actuator mechanism 62 is moved to an “on” position. The processor 84 sends a signal to the amplifier 48. The amplifier 48 utilizes power from the battery 56 to amplify the power and provide amplified power to the actuator motor 60. The actuator motor 60 is preferably a servo-motor to provide for control over the degree of rotation of its shaft to move the actuator mechanism 62 in FIG. 1 upward into the “on” position.

Following step 108, the processor 84 executes step 110. The processor 84 continually compares the time provided by the clock 82 to the “off” time 92 in the memory 86. If the clock time is less than the “off” time, no further action is executed. If the clock time is larger than the “off” time, step 112 is executed.

At step 112, the actuator mechanism 62 in FIG. 1 is moved to an “off” position. The processor 84 sends a signal to the amplifier 48, which is amplified and provided to the actuator motor 60. The signal may, for example, reverse the rotation of the shaft by the same degree as when the actuator mechanism 62 was moved to the “on” position. The actuator mechanism 62 then moves down into the “off” position.

Following step 112, the processor 84 may again carry out step 106. Steps 106, 108, 110, and 112 can be repeated until the user disarms the actuator system 16.

It can thus be seen that the user can use the actuator system 16 to alternately switch the switch 12 on and off at predetermined times. The switch 12 will, for example, be switched on at a certain time every day, and be switched off at a certain time every day, and the process will be repeated every 24 hours. The switch 12 can be connected to a light, and the light is switched on and off when the user is away from home.

Although “on” and “off” times are used in the example, another reference source can be used to switch a switch on and off. The reference source 46 can, for example, include a receiver for a cellular phone, and the user can switch a switch on and off by calling the receiver. The reference source 46 can include a light sensor instead of or in addition to a manual input device, so that a light is switched on when ambient light falls below a predetermined intensity and switches off when ambient light is above a predetermined intensity. In another example, the reference source 46 can include a motion sensor and a clock so that a light is switched on when motion is detected and switched off after a predetermined period of time after motion is not detected anymore.

In the given example, a switch 12 is described as an example of a power modifier that uses a relay 26 to discreetly switch power on and off. Another power modifier may have a power-modifying portion that simply increases or reduces power without necessarily switching the power on and off. Instead of a switch member such as the switch member 28, such a power modifier may have a power modifier member that is rotatable. In an alternate embodiment, it is also possible to use a securing device such as a fastener instead of the magnets 52 and 54 to secure an actuator system directly or indirectly to a wall.

While certain exemplary embodiments have been described and shown in the accompanying drawings, it is to be understood that such embodiments are merely illustrative and not restrictive of the current invention, and that this invention is not restricted to the specific constructions and arrangements shown and described since modifications may occur to those ordinarily skilled in the art.

What is claimed:

1. For a power modifier comprising a power modifier body that is secured to a wall, first and second terminals over which a voltage is applied, a power-modifying portion that modifies electric power from the first terminal to the second terminal, and a power modifier member, movably secured to the power modifier body and connected to the power-modifying portion, so that the power-modifying portion modifies the electric power upon movement of the power modifier member relative to the power modifier body and the wall, an actuator system, comprising:
an actuator body that is securable in a stationary position relative to the wall;
a reference source; and
an actuator connected to the reference source, the actuator having a stationary portion secured in a stationary position to the actuator body and a movable portion that moves relative to the actuator body, the movable portion having a surface that engages with the power modifier member of the power modifier to move the power modifier member in response to the reference source.

2. The actuator system of claim 1, wherein the power modifier member is a lever arm that is pivoted by the movable portion of the actuator.

3. The actuator system of claim 1, wherein the power modifier body is securable within an opening in a wall, and a face plate is securable over the opening in the wall, further comprising:
a securing device, having a first component securable to the face plate and a second component securable to the actuator body, thereby securing the actuator body to the face plate.

4. The actuator system of claim 3, wherein the first and second components of the securing device include first and second magnets with their polarities in substantially the same direction so that they attract one another.

5. The actuator system of claim 1, wherein the reference source includes a clock.

6. The actuator system of claim 5, further comprising:
an input device;
a processor; and
memory, the memory having a program stored thereon that is executable by the processor to allow for setting of an actuation time, the processor comparing the actuation time with a time provided by the clock for purposes of moving the movable portion of the actuator.

7. The actuator system of claim 1, further comprising:
battery terminals, the reference source being connected to the battery terminals.

8. The actuator system of claim 1, further comprising:
battery terminals, the actuator motor being connected to the battery terminals.

9. The actuator system of claim 1, further comprising an amplifier between the reference source and the actuator motor.

10. The actuator system of claim 1, wherein the movable portion of the actuator moves the power modifier member in first and second opposing directions so that the movable portion moves the power modifier member to respectively increase and decrease the electric power from the first terminal to the second terminal.

11. The actuator system of claim 10, wherein the reference source includes a clock, further comprising:
an input device;
a processor; and
memory, wherein a program is stored in the memory, the program being executable by the processor to allow for entering of first and second actuation times, the processor comparing the first and second actuation times with a time provided by the clock to move the movable portion into the first and second directions, respectively.
